(19) United States
(12) Patent Application Publication
(10) Pub. No.: US 2008/0148952 A1
(43) Pub. Date: Jun. 26, 2008

(54) Brewing apparatus for a coffee machine

(75) Inventor: Stephan Ruckstuhl, Neudedorf (CH)

Correspondence Address: SUGHRUE MION, PLLC, 2100 PENNSYLVANIA AVENUE, N.W., SUITE 800, WASHINGTON, DC, 20037, US

(73) Assignee: Eldom Rothrist AG, Rothrist (CH)

(21) Appl. No.: 11/641,850

(22) Filed: Dec. 20, 2006

(51) Int. Cl. A47J 31/44

(52) U.S. Cl. 99/279

(57) ABSTRACT

A brewing apparatus for a coffee machine, in particular for domestic use, having a housing which encloses a brewing chamber and has a nozzle assembly arranged on one side and a base with an outflow for the brewed fluid arranged on an opposite side. A flexible sealing element is provided between the nozzle assembly and housing. The brewing chamber is arranged on one side and a fluid-fillable chamber is arranged on the opposite side. The sealing element is moveable in the direction of the brewing chamber via an increase in pressure in the chamber. The chamber is connected to a venting valve in order to relieve the sealing element of loading.

### TECHNICAL FIELD

The present invention relates to a brewing apparatus for a coffee machine, in particular for domestic use, having a housing which encloses a brewing chamber and has a nozzle assembly arranged on one side and a base with an outflow for the brewed fluid arranged on the opposite side, a flexible sealing element being provided between the nozzle assembly and housing and having the brewing chamber arranged on one side and a fluid-fillable chamber arranged on its opposite side, and it being possible for the sealing element to be moved in the direction of the brewing chamber via an increase in pressure in the chamber.

### BACKGROUND ART

EP 1625813 A1 discloses a brewing apparatus for a coffee machine in which a brewing chamber is bounded on one side by a flexible sealing element which can be moved in relation to the brewing chamber during the brewing operation, an extraction substance which is located in the brewing chamber thus always being enclosed to good effect on all sides. This improves the quality of the brewing operation, the sealing element, once subjected to pressure, being moved back into a starting position again. If, however, the pressure is not fully dissipated, the sealing element may remain deformed, which can have an adverse effect on functionality.

### SUMMARY OF THE INVENTION

The object of the present invention is thus to provide a brewing apparatus for a coffee machine which ensures reliable sealing of the brewing chamber and, in addition, is not susceptible to wear.

This object is achieved by a brewing apparatus having the features of claim 1.

According to the invention, the chamber which is adjacent to the flexible sealing element is connected to a venting valve in order to relieve the sealing element of loading, so that, following the brewing operation, the pressure in the chamber is reduced to ambient pressure and the sealing element can move back freely into the starting position. The venting valve here may be of comparatively small design since it is usually only small quantities of fluid, mostly air or water, which have to be discharged. This ensures, however, the same pressure on both sides of the sealing element, this then avoiding permanent deformation of the sealing element when not in use.

According to a further configuration of the invention, the chamber is connected to a supply line to the nozzle assembly via a pressure relief valve. The supply line to the nozzle assembly is usually designed as a heating line, so that a pressure can form in the supply line in a reheating phase. It is intended here, however, to prevent renewed opening of the nozzle assembly and the associated dripping into the coffee cup. It is thus possible to evacuate a corresponding pressure in the reheating phase via the pressure relief valve, the chamber then ensuring pressure equalization via the venting valve. In addition, the pressure relief valve may also act as a backflow check valve which, in the pressureless state, prevents the supply line from emptying into the nozzle assembly. This allows particularly good metering of the fluid fed.

According to a still further configuration of the invention, the chamber can be subjected to pressure via a pump which also feeds the fluid to the nozzle assembly. Consequently, just one pump is required for feeding the water to the nozzle assembly and for subjecting the chamber to pressure. The lines can be branched downstream of the pump and upstream of a heating element.

The nozzle assembly is, according to a still further configuration of the invention, closed via a nozzle-assembly valve which is opened via the sealing element when the pressure in the chamber increases. The quantity of fluid fed by way of the nozzle-assembly valve can thus be metered to particularly good effect.

For compact configuration of the brewing apparatus, the venting valve and pressure relief valve may be coupled to one another via a common tappet. This reduces the number of components required, the tappet being prestressed into a position in which the pressure relief valve is closed and the venting valve is open. It is only when the pressure in the chamber increases in order to feed a fluid that the venting valve is closed and the pressure relief valve is opened.

### BRIEF DESCRIPTION OF THE DRAWINGS

The invention is explained in more detail hereinbelow by way of an exemplary embodiment and with reference to the accompanying drawings, in which:

FIG. 1 shows a sectional side view of a coffee machine with a brewing apparatus according to the invention, and

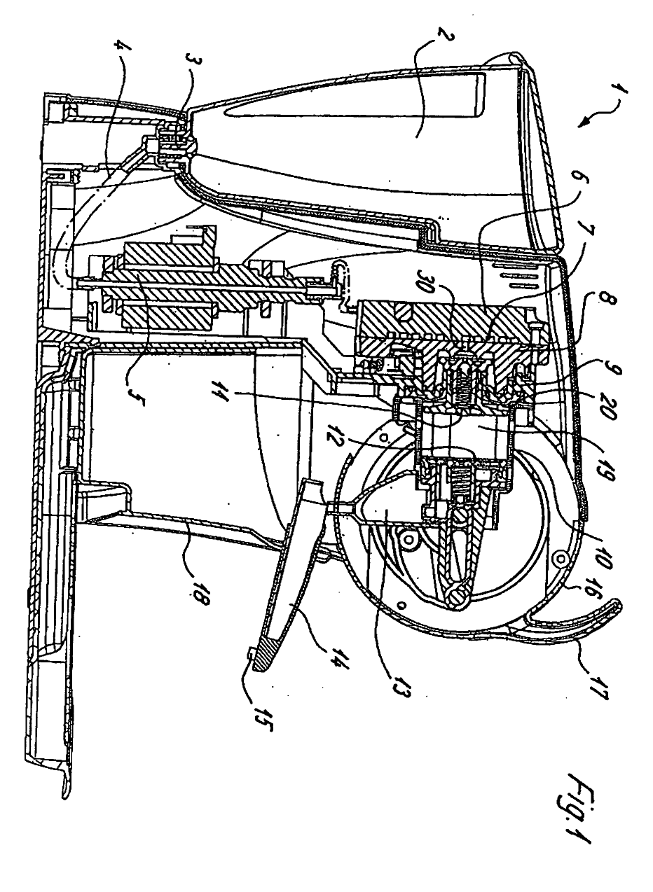

FIG. 2 shows a detail-specific view of the brewing apparatus of the coffee machine of FIG. 1.

### DESCRIPTION OF THE PREFERRED EMBODIMENTS

A coffee machine 1 comprises a storage container 2 for clean water, the storage container having provided on it an outlet valve 3 which is connected to a pump 5 via a line 4. By means of the pump 5, the water can be led to a heating plate 6 which contains helical through-passages 7 in which the water can be heated. Provided alongside this is a plate 8 which forms part of a nozzle assembly and in which is provided a supply line 30 for the heated water. Installed on the plate 8 is a mount 9 for a sealing element 20 which is of essentially annular design and has a nozzle 11 provided in its center. Via the nozzle 11, the heated water can flow into a brewing chamber 19 which is enclosed by a housing 10. Provided on the opposite side of the nozzle 11 is a base 12 which is intended for bounding the brewing chamber 19 and which contains an outflow, so that the fluid brewed flows through a funnel-like outlet 13 to an extension arm 14, on which an outlet opening 15 is provided for the purpose of filling coffee cups.

The coffee machine 1 comprises a brewing chamber 19 in which it is possible to insert one or more portion packs with coffee. Provided for this purpose is a covering 16 on which is formed a handle 17, via which the housing 10 can be released from the nozzle assembly and pivoted via an actuating mechanism, so that the brewing chamber 19 is filled from above. The covering 16 is then closed and the housing 10 is moved into the position shown. Following the brewing operation, the portion packs are then emptied into a collecting container 18 in order for the brewing chamber 19 to be filled anew. For the subject matter of the present application, however, it is possible to use quite different actuating mechanisms for the purpose of filling the brewing apparatus with one or more portion packs.

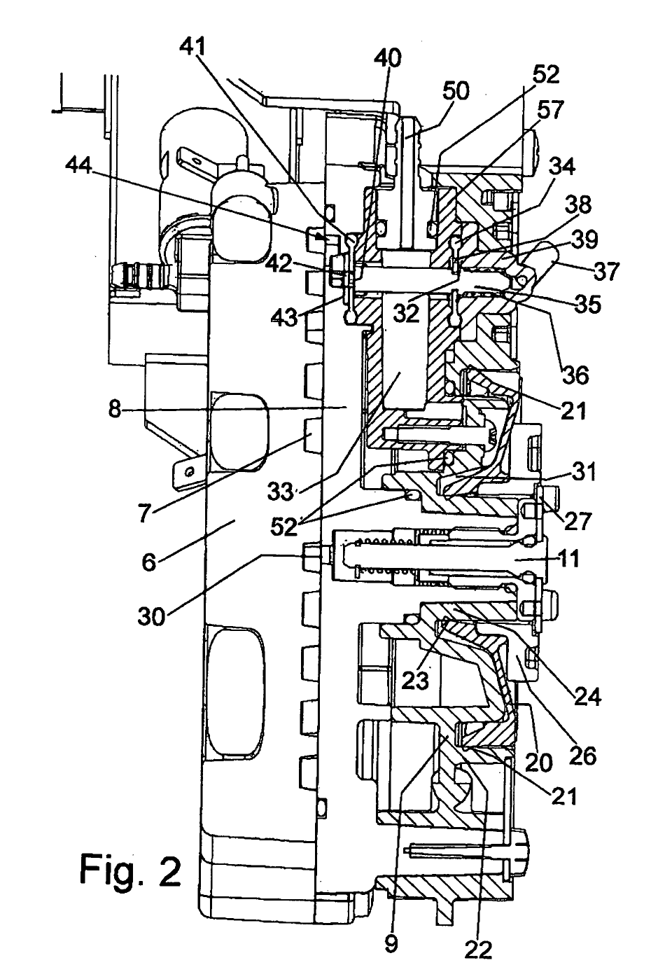

FIG. 2 illustrates part of the brewing apparatus of the coffee machine 1 in detail.

The annular sealing element 20 is fitted on the mount 9, in which case, on the sealing element 20, an outer sealing lip butts against a crosspiece 22 of the mount 9 and an inner sealing lip 23 butts against a cross-piece 24 of the mount 9. An annular chamber 31 is thus formed between the mount 9 and sealing element 20 and ensures that the sealing element 20 is moved in the direction of the brewing chamber 19 when the chamber 31 is subjected to pressure. Coupled to the sealing element 20 here is a plate-like pressure-exerting element 26 which can be pressed against the wall of a portion pack containing ground coffee. The sealing element 20 and the plate-like pressure-exerting element 26 here can be moved up to a stop which is formed by a projecting flange 27 on the nozzle.

The chamber 31 here is connected directly to a valve chamber 33 which can be supplied with water via a supply line 50, the water being fed by the pump 5. The supply line 50 may be connected here upstream of the heating plate 6, downstream of the pump 5.

Two valves are provided on the valve chamber 33. A venting valve 32 connects the valve chamber 33 to a venting line 37. The venting valve 32 here is formed by a diaphragm 34 containing one or more openings 38. The diaphragm 34 here is secured, on one side, on an insert 51 and the mount 9 and, on the inside, on a movable tappet 35. The tappet 35 is prestressed toward the left in FIG. 2 via a spring 36, so that the opening 38 is not closed by a wall of a valve housing 39.

If the pressure in the valve chamber 33 is increased by the pump 5, the diaphragm 34 is subjected to pressure and moves the prestressed tappet 35 to the right, so that the venting valve 32 is closed.

Provided on the opposite side of the tappet 35 is a pressure relief valve 44, which is connected to the helical through-passages 7 of the heating plate 6. The pressure relief valve 44 comprises a second diaphragm 41, which is secured on the outside between the mount 51 and the plate 8. The diaphragm 41 here is supported on the plate 8 via a supporting disk 43, the diaphragm 41 and supporting disk 43 being provided with a through-opening 42 which is connected to the through-passages 7. The through-opening 42 is closed by an end side 40 of the tappet 35.

Furthermore, the insert 51, sealed via a plurality of sealing elements 52 is accommodated between the plate 8 and the mount 9.

The operation of the brewing apparatus is described in detail hereinbelow, FIG. 2 showing the pressureless state in which the pump 5 has been switched off and the venting valve 32 is open.

If the pump 5 is switched on, the water flows, via the water inlet 50, into the valve chamber 33 and the chamber 31. The sealing element 20 thus moves in relation to the brewing chamber 19, seals the latter and, at the same time, opens a nozzle-assembly valve, so that heated water can flow through the brewing chamber 19 by way of the nozzle 11. The built-up pressure in the through-passages 7 is thus evacuated into the brewing chamber 19.

In a first phase, the end edge 40 of the tappet 35 butts against the through-opening 42, so that the through-passages 7 are separated off from the valve chamber 33. At the same time, the valve chamber 33 is vented via the opening 38 of the venting valve 32. This allows trapped air and possibly water to be discharged to the venting line 37.

If the pressure in the valve chamber 33 then increases, the tappet 35 moves to the right, on account of the diaphragm 34, and closes the venting valve 32. This simultaneously releases the through-opening 42 in relation to the through-passages 7. The brewing apparatus is then located in the operating position and the heated water can flow into the brewing chamber 19 by way of the nozzle 11. In this state, there is equal static pressure in the brewing chamber 11, the through-passages 7, the valve chamber 33 and the chamber 31.

If the pump 5 is switched off, the pressure dissipates, in the first instance, via the nozzle 11 and the nozzle-assembly valve, until the spring 36 forces the tappet 35 onto the opening 42 again and the venting valve 32 is thus opened and the opening 38 no longer butts against the housing cover 39. The sealing element 20 is thus relieved of loading and can move back into the starting position, as a result of which the nozzle-assembly valve is also closed.

The valve chamber 32 is vented via the opening 38 in the diaphragm 34. Venting here, on the one hand, causes the sealing element 20 to be fully relieved of loading and, on the other hand, ensures that the nozzle-assembly valve can close again without force being applied. Furthermore, the pump 5 need not take in counterpressure if there is a lack of water in the tank 2, which accelerates this operation to a considerable extent.

The pressure relief valve 42 also performs the function of a backflow check valve, so that it is not possible to empty the water in the through-passages 7 of the heating plate 6. This is because the pressure relief valve 44 and the nozzle-assembly valve ensure that the water contained in the through-passages 7 remains there and the through-passages 7 cannot empty during the reheating phase. Particularly precise metering of the quantity of liquid is possible as a result.

Furthermore, the pressure relief valve 44 has a function to perform in the reheating phase, when the pressure in the through-passages 7 of the heating plate 6 increases as a result of heating. The force of the spring 36 may be such that the pressure in the reheating phase is limited and, if required, the tappet 35 is moved to the right by the positive pressure occurring and the fluid can be discharged into the valve chamber 33 in order to equalize pressure in the through-passages. It is conceivable here to set the pressure difference for initiating the pressure relief valve by a corresponding configuration of the spring 36.

In the exemplary embodiment illustrated, the venting valve 32 and pressure relief valve-44 are coupled to one another via a common tappet 35. It is, of course, also possible to provide the venting valve 32 and pressure relief valve 44 separately from one another. Other valves may also be used.

1. A brewing apparatus for a coffee machine, in particular for domestic use, having a housing which encloses a brewing chamber and has a nozzle assembly arranged on one side and a base with an outflow for the brewed fluid arranged on an opposite side, a flexible sealing element being provided between the nozzle assembly and housing and having the brewing chamber arranged on one side and a fluid-fillable chamber arranged on the opposite side, and it being possible for the sealing element to be moved in the direction of the brewing chamber via an increase in pressure in the chamber, wherein the chamber is connected to a venting valve in order to relieve the sealing element of loading.

2. The brewing apparatus as claimed in claim 1, wherein the chamber is connected to a supply line to the nozzle assembly via a pressure relief valve.

3. The brewing apparatus as claimed in claim 2, wherein the pressure relief valve also acts as a backflow check valve which, in the pressureless state, prevents the supply line from emptying into the nozzle assembly.

4. The brewing apparatus as claimed in claim 1, wherein the chamber can be subjected to pressure via a pump which also feeds the fluid to the nozzle assembly.

5. The brewing apparatus as claimed in claim 1, wherein the nozzle assembly is closed via a nozzle-assembly valve which is opened via the sealing element when the pressure in the chamber increases.

6. The brewing apparatus as claimed in claims 1, wherein the venting valve and pressure relief valve are coupled to one another via a common tappet.

7. The brewing apparatus as claimed in claim 6, wherein the tappet is prestressed into a position in which the pressure relief valve is closed and the venting valve is open.

8. The brewing apparatus as claimed in either of claims 6 or 7, wherein the venting valve comprises a diaphragm coupled to the tappet.
